(19) United States
(12) Patent Application Publication
(10) Pub. No.: US 2023/0256748 A1
(43) Pub. Date: Aug. 17, 2023

(54) CARTRIDGE AND PRINTER

(71) Applicant: Videojet Technologies Inc., Wood Dale, IL (US)

(72) Inventors: Yong Qiang Wang, West Chicago, IL (US); Peter Nguyen, Glendale Heights, IL (US)

(21) Appl. No.: 18/308,598

(22) Filed: Apr. 27, 2023

Related U.S. Application Data
(63) Continuation of application No. PCT/US21/56969, filed on Oct. 28, 2021.

(30) Foreign Application Priority Data
Oct. 29, 2020 (GB) 2017190.6

(51) Int. Cl. B41J 2/175

(52) U.S. Cl. CPC B41J 2/17553; B41J 2/17513; B41J 2002/17516

(57) ABSTRACT

There is provided a cartridge for storing and dispensing liquid for use with an inkjet printer, the cartridge comprising: a collapsible reservoir enclosing an internal space for storage of the liquid, wherein: the reservoir comprises a first wall portion and a second wall portion, the first wall portion defining a first region of the internal space, the second wall portion defining a second region of the internal space, the first region and the second region being in fluid communication with each another; and the first wall portion and the second wall portion are configured such that at least a part of the second wall portion collapses more easily than the first wall portion when the liquid is withdrawn from the reservoir; an outlet configured to dispense the liquid; and a holder configured to receive an electronic data storage device, wherein the holder is provided on the first wall portion.

The present invention relates to inkjet printing and more particularly to a cartridge for storing and dispensing liquid for use with an inkjet printer, such as a continuous inkjet printer, and an inkjet printer including the cartridge.

In inkjet printing systems the print is made up of individual droplets of ink generated at a nozzle and propelled towards a substrate. There are two principal systems: drop on demand where ink droplets for printing are generated as and when required; and continuous inkjet printing in which droplets are continuously produced and only selected ones are directed towards the substrate, the others being recirculated to an ink supply.

Continuous inkjet printers supply pressurised ink to a print head drop generator where a continuous stream of ink emanating from a nozzle is broken up into individual regular drops by, for example, an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate).

In continuous inkjet printing a character is printed from a matrix comprising a regular array of potential drop positions. Each matrix comprises a plurality of columns (strokes), each being defined by a line comprising a plurality of potential drop positions (e.g. seven) determined by the charge applied to the drops. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a tank of the ink supply system via a filter and delivers it under pressure to the print head. As ink is consumed the tank is refilled as necessary from a replaceable ink cartridge that is releasably connected to the tank by a supply conduit. The ink is fed from the tank via a flexible delivery conduit to the print head. The unused ink drops captured by the gutter are recirculated to the tank via a return conduit by a pump. The flow of ink in each of the conduits is generally controlled by solenoid valves and/or other like components.

As the ink circulates through the system, there is a tendency for it to thicken as a result of solvent evaporation, particularly in relation to the recirculated ink that has been exposed to air in its passage between the nozzle and the gutter. In order to compensate for this, “make-up” solvent is added to the ink as required from a replaceable solvent cartridge so as to maintain the ink viscosity within desired limits. This solvent may also be used for flushing components of the print head, such as the nozzle and the gutter, in a cleaning cycle. Therefore, a typical continuous inkjet printer has both a replaceable ink cartridge and a replaceable solvent cartridge. In this description, both ink cartridge and solvent cartridge are referred to as cartridges.

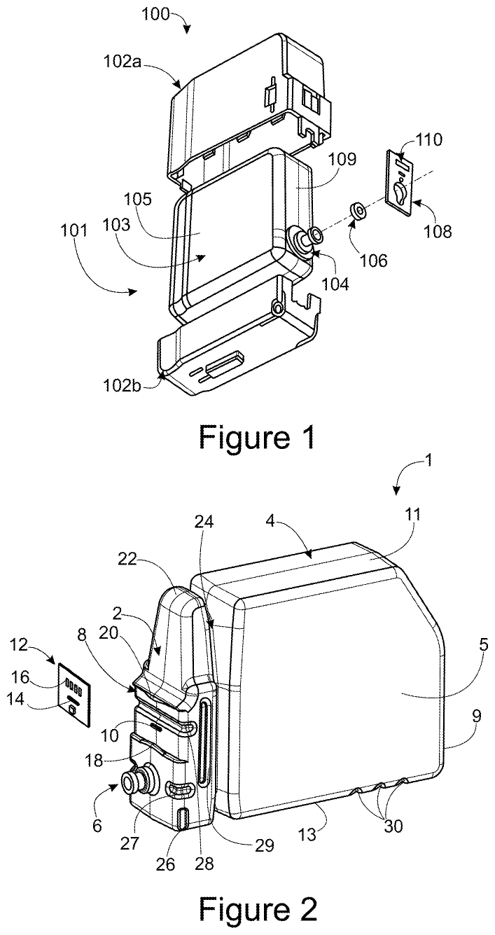

FIG. 1 is an exploded, perspective view of a known replaceable cartridge 100. As shown in FIG. 1, the cartridge 100 has an inner collapsible bottle 101 which is encased in a rigid outer casing 102. The outer casing may also be referred to as a housing. The outer casing 102 includes two parts 102a, 102b which may be releasably joined together by snap fits. The bottle 101 has a reservoir 103 for storage of liquid (such as ink or solvent) and an outlet 104 for dispensing the liquid. The reservoir 103 includes two opposing face walls 105 and perimeter walls 109 surrounding the face walls 105. The outlet 104 provides an aperture between the internal space of the reservoir 103 and the outside. The outlet 104 is fitted with a septum seal 106. There is no venting hole provided in the bottle 101. Therefore, the pressure within the reservoir 103 is generally maintained at a pressure lower than atmospheric pressure. The outer casing 102 is provided with apertures so that the outside of the bottle 101 is subject to atmospheric pressure at all times. An electronic data storage device 108 in the form of an integrated circuit is provided with electrical contacts 110. The electronic data storage device 108 is attached to a card slot provided on the outer casing 102. Information stored in the electronic data storage device 108 typically includes: the type and the characteristics of liquid stored in the reservoir 103, the amount of liquid remaining in the reservoir 103, and/or the number of times that the bottle 101 has been refilled, etc.

In use, the cartridge 100 is attached to an inkjet printer. To ensure the cartridge 100 is brought into correct registration with supply conduits, the cartridge 100 is typically connected to the ink supply system of the printer via a docking station comprising a cartridge holder. When the cartridge 100 is correctly docked within the cartridge holder, the septum seal 106 is pierced and the outlet 104 is connected, via fluid-tight means (e.g., a fluid connector), to a pump of the ink supply system. The pump reduces the pressure in the fluid connector until the pressure in the fluid connector is lower than the pressure in the internal space of the reservoir 103. This leads to the liquid being dispensed from the reservoir 103 via the fluid connector to the ink supply system. The ink supply system may also comprise a contact pad for engaging with the electrical contacts 110 so as to read information from and/or write information to the electronic data storage device 108. When the cartridge 100 is correctly docked, the fluid communication between the outlet 104 and the printer and the electrical communication between the electronic data storage device 108 and the printer are both established.

With liquid being dispensed from the reservoir 103, the bottle 101 continues to collapse (or deform) in order to accommodate the decreasing internal volume of the reservoir 103. In an example, the overall volume of the bottle 101 is 770 ml, and the filling volume of liquid within the reservoir 103 is 750 ml, leaving a head space of 20 ml. A pump providing 400 mbar vacuum may be used to withdraw the liquid from the bottle 101. When all of the liquid has been withdrawn from the reservoir 103, the bottle 101 becomes substantially fully collapsed and severely deformed, achieving an empty internal space of 20 ml eventually. However, the shape of the outer casing 102 remains unchanged. The outer casing 102 is useful to hold the outlet 104 in position, and to maintain the correct positioning of the cartridge 100 with respect to the inkjet printer, so as to ensure that the fluid communication between the outlet 104 and the printer and the electrical communication between the electronic data storage device 108 and the printer remain intact irrespective of the collapse of the bottle 101.

Therefore, the known cartridge 100 is two-piece cartridge assembly which includes the inner collapsible bottle 101 and the rigid outer casing 102, and the rigid outer casing 102 serves to ensure that the collapse of the inner bottle 101 would not affect the use of cartridge 100 in an inkjet printer. However, to make the outer casing 102 rigid, the outer casing 102 often has a thick wall and is heavy in weight. The outer casing 102 therefore increases the weight and reduces the material efficiency of the cartridge 100.

It is an object of the present invention, among others, to provide an improved cartridge for use with an inkjet printer (such as a continuous inkjet printer) which solves problems associated with known cartridges, whether identified herein or otherwise.

According to a first aspect of the present disclosure, there is provided a cartridge for storing and dispensing liquid for use with an inkjet printer, the cartridge comprising: a collapsible reservoir enclosing an internal space for storage of the liquid, wherein: the reservoir comprises a first wall portion and a second wall portion, the first wall portion defining a first region of the internal space, the second wall portion defining a second region of the internal space, the first region and the second region being in fluid communication with each another; and the first wall portion and the second wall portion are configured such that at least a part of the second wall portion collapses more easily than the first wall portion when the liquid is withdrawn from the reservoir; an outlet configured to dispense the liquid; and a holder configured to receive an electronic data storage device, wherein the holder is provided on the first wall portion.

It would be appreciated that the expression “an outlet configured to dispense the liquid” does not imply any limitation to the presence of the liquid within the cartridge and may be used interchangeably with “an outlet for dispensing the liquid”. Similarly, the expression “a holder configured to receive an electronic data storage device” does not imply any limitation to the presence of the electronic data storage device and may be used interchangeably with “a holder for receiving an electronic data storage device”.

According to a second aspect of the present disclosure, there is provided a cartridge for storing and dispensing liquid for use with an inkjet printer, the cartridge comprising: a collapsible reservoir having at least one wall enclosing an internal space for storage of the liquid, wherein: the internal space of reservoir comprises a first part and a second part which are in fluid communication with each other; the at least one wall comprises a first wall defining the first part and a second wall defining the second part; and the first wall and the second wall are configured such that at least a part of the second wall collapses more easily than the first wall when the liquid is withdrawn from the reservoir; an outlet for dispensing the liquid; and a holder for releasably receiving an electronic data storage device, wherein the holder is provided on the first wall.

In the present disclosure, the terms “first wall” and “second wall” are used interchangeably with “first wall portion” and “second wall portion”, respectively. Further, the terms “first part” and “second part” of the internal space of the reservoir are used interchangeably with “first region” and “second region” of the internal space of the reservoir, respectively.

By making at least a part of the second wall portion to collapse more easily than the first wall portion when the liquid is withdrawn from the reservoir, the deformation of the second wall portion accommodates a majority (if not all) of the reduced internal volume of the reservoir which is caused by the dispensing of the liquid. Therefore, the first wall portion is able to substantially maintain its shape when the liquid is withdrawn from the reservoir. By further arranging the holder (which is for receiving an electronic data storage device) on the first wall portion, the position and the shape of the holder remain substantially unchanged during the dispensing of the liquid. Therefore, the electronic data storage device received by the holder is able to maintain an effective electrical contact with the inkjet printer during the dispensing of the liquid.

Accordingly, the cartridge of the present invention can be installed directly onto an inkjet printer to establish a fluid communication (via the outlet) and an electrical communication (via the electronic data storage device received by the holder) with the printer, without requiring any other components (such as, a rigid outer casing). This is in contrast to the prior cartridge which uses a rigid outer casing which encloses the collapsible reservoir to hold the electronic data storage device and to maintain the correct positioning of the reservoir.

It would be understood that that the first and second wall portions may be different parts of the same wall, and/or may be formed at the same time during a single manufacturing step (e.g., rotational or blow moulding). It would further be understood that the first and second regions of the internal space may be different regions of the same volume.

By the expression “the first wall portion defining a first region of the internal space” and “the second wall portion defining a second region of the internal space”, it is intended to mean that the first region is at least partially surrounded by the first wall portion, and that the second region is at least partially surrounded by the second wall portion.

The volume of the first region and the volume of the second region may be configured such that a desired filling volume of liquid occupies substantially the full internal volume of the second region and more than 60% of the volume of the first region is unfilled by liquid but filled by gas (e.g., air) as the head space.

“Collapsible reservoir” means that the reservoir is configured to collapse when liquid is dispensed from the reservoir. In general, such a reservoir does not have a venting hole, and the pressure within the reservoir is not allowed to equalise with the external environment. A negative pressure is typically maintained in the internal space of the collapsible reservoir.

The expression “a first region and a second region which are in fluid communication with each other” is intended to mean that liquid and/or gas (e.g., air) is able to flow between the first region and the second region.

The holder may be for releasably receiving the electronic data storage device.

The holder may be releasably attached to the first wall portion.

The holder may be releasably attached to the first wall portion by a snap-fit connection.

Alternatively, the holder may be integrally formed with the first wall portion. Accordingly, the cartridge may be a unitary cartridge. “Unitary” means that the cartridge forms a single entity, and is a single-piece item. This is in contrast to the prior art cartridge which is a two-piece item, including an inner collapsible bottle and a separate rigid outer casing.

The reservoir may be configured such that a collapse of the second wall portion reduces an overall volume of the cartridge.

The second wall portion may have an inner surface and an opposed outer surface, wherein the inner surface is configured to directly contact the liquid, and the outer surface forms part of an exterior surface of the cartridge.

The outlet may be provided on the first wall portion.

The first wall portion advantageously maintains the correct positioning of the outlet with respect to the inkjet printer during the dispensing of the liquid from the reservoir.

The reservoir may be partially collapsible.

“Partially collapsible” means that at least a part of the reservoir (e.g., the first region) is not collapsed/deformed or is only collapsed/deformed to a limited extent that doesn't affect the electrical and fluid communications with a printer when all of the liquid is withdrawn from the reservoir.

The at least one wall may be made of a non-elastic and flexible material.

The second region may have a larger volume than the first region.

The first region may form a first chamber of the reservoir, and the second region may form a second chamber of the reservoir.

The second region, the first region and the outlet may be arranged along a first direction.

The reservoir may define a flow path originating from the second region, then leading through the first region, and then leading to the outlet.

The first wall portion may comprise a first reinforcing structure which is configured to reinforce the rigidity of at least a part of the first wall portion.

The first reinforcing structure may comprise one or more indents and/or one or more protrusions.

The first reinforcing structure may be provided around the outlet and/or the holder.

The holder may be configure to releasably engage with the first reinforcing structure.

The second wall portion defining the second region may comprise two opposing face walls and at least one peripheral wall connecting the two opposing face walls.

The two opposing face walls may be configured to move towards each other so as to reduce the overall volume of the cartridge when the liquid is withdrawn from the internal space.

The at least one peripheral wall may comprise a second reinforcing structure which is configured to reinforce the rigidity of the peripheral wall.

The reinforced peripheral wall may be configured to be in contact with a mounting arrangement (e.g., a cartridge holder) of an inkjet printer in use.

The second reinforcing structure may comprise one or more indents and/or one or more protrusions.

The cartridge may be adapted to prevent air from entering the internal space from outside of the cartridge as the liquid is dispensed from the outlet.

In other words, the reservoir does not have a venting hole.

The cartridge may be for use with a continuous inkjet printer.

The internal space of the reservoir may be configured to be filled with both liquid and gas.

The cartridge may be adapted to prevent gas in the internal space from escaping the reservoir to outside of the cartridge.

The liquid and gas may be filled into the internal space of the reservoir during a filling process of the cartridge. The gas may comprise air.

The gas filled into the reservoir may be configured to substantially occupy the first region when all of the liquid has been dispensed from the outlet in use.

A total volume of the internal space of the reservoir may comprise a sum of a volume of the first region and a volume of the second region. A filling volume of liquid within the reservoir may be up to a sum of the volume of the second region and 40% of the volume of the first region.

That is, a filling volume of gas within the reservoir may be at least 60% of the volume of the first region. The filling volume of gas may provide the head space of the reservoir.

In use, as liquid is dispensed from the outlet, the gas filled into the reservoir expands to compensate for the volume of the dispensed liquid, thereby lowering the internal pressure of the reservoir. The pressure difference is thus established between the internal pressure of the reservoir and the outside of the cartridge. Since the second wall portion deforms more easily than the first wall portion, the pressure difference causes the second wall portion to deform or collapse, and the gas inside the second chamber and the remaining liquid move towards or into the first region. When all of the liquid is withdrawn from the reservoir, the second region of the reservoir has substantially completely collapsed, and the gas originally filled into the reservoir occupies the internal space of the first region. Since the original filling volume of gas within the reservoir is at least 60% of the volume of the first region, and further because this volume of gas fills the first region at the end of liquid dispensing, the pressure difference between the first region and the outside of the cartridge is not sufficient to crush the first wall portion when all of the liquid is withdrawn from the reservoir. That is, the rigidity of the first wall portion is sufficient to prevent collapse when the pressure is such that an initial volume of gas (at or slightly lower than the atmospheric pressure) of around 60% of the volume of the first region is caused to expand to fill substantially the entire volume of the first region. Therefore, the first wall portion or the first region would not substantially deform when all of the liquid is withdrawn from the reservoir. As such, the electrical contact between the electrical data storage device and the printer as well as the fluid connection between the outlet and the printer are ensured.

The cartridge may further comprise the electronic data storage device received by the holder.

The reservoir may further comprise a linking structure which links at least a part of a boundary of the first wall portion to at least a part of a boundary of the second wall portion.

The linking structure may be configured to improve the deformability of at least a part of the second wall portion. In particular, the linking structure may allow the second wall portion to easily deform so as to accommodate the reduced volume of the internal space caused by the dispensing of the liquid. As such, the first wall portion would experience less force and would not substantially deform as the liquid is dispensed from the reservoir.

Further or alternatively, the linking structure may be configured to isolate the deformation of at least a part of the second wall portion from the first wall portion, such that the deformation of the second wall portion would not substantially affect the structure or the shape of the first wall portion.

The linking structure may comprise a groove. The groove may link at least a part of a boundary of the first wall portion to a boundary of one of the opposing face walls.

The groove may extend along at least two sides of the respective face wall.

The groove may be U-shaped, and may extend along (or surround) three sides of the respective face wall.

Alternatively, the groove may be loop-shaped, and may extend along (or surround) all four sides of the respective face wall.

The linking structure may comprise a collar which defines a fluid communication path between the first region and the second region. A cross section of the fluid communication path may have a smaller size than a cross section of the first region and/or the second region.

The collar may be arranged to link a boundary of the first wall portion to a boundary of the second wall portion. Due to the small cross-sectional size of the collar, the collar is more rigid than the second wall portion. The collar is useful to isolate deformation of the second wall portion from the first wall portion, such that deformation of the second wall portion would not substantially affect the structure or shape of the first wall portion. Further, the cartridge can be held at the collar when it is moving on a conveyer, and during filing and capping processes.

The second region, the fluid communication path, the first region and the outlet may be arranged along a first direction.

The flow path defined by the reservoir may originate from the second region, then lead through the fluid communication path, then lead through the first region, and then leading to the outlet.

A material of the at least a part of the second wall portion may be more flexible than a material of the first wall portion.

A thickness of the at least a part of the second wall portion may be thinner than a thickness of the first wall portion.

The first wall portion and the second wall portion may be made of the same material.

By having a thinner thickness, the at least a part of the second wall portion is more flexible than the first wall portion. As such, when the liquid is dispensed from the reservoir, the second wall portion quickly deforms to accommodate the reduced volume of the internal space caused by the dispensing of the liquid, and the first wall portion would experience less force and would not substantially deform.

The first region may comprise a tapered end.

The tapered end may be provided at a side of the first region opposite to the outlet.

The tapered end may have a smaller depth than the remaining first region or the second region along a second direction which is perpendicular to the opposing face walls

The tapered end improves the rigidity of the first wall portion such that the first wall portion would not substantially deform as the liquid is dispensed from the reservoir.

According to a third aspect of the present disclosure, there is provided an inkjet printer comprising: a cartridge according to the first aspect, an electronic data storage device received by the holder of the cartridge, and a mounting arrangement which directly receives the cartridge.

“Directly receives” means that the cartridge in itself can be installed onto the mounting arrangement without requiring any additional structures (e.g., an outer casing required by prior cartridges).

The mounting arrangement may comprise a fluid connector for engaging with the outlet of the cartridge, and an electrical contact arranged to communication with the electronic data storage device.

According to a fourth aspect of the present disclosure, there is provided a computer program comprising computer executable instructions that, when executed by a processor, cause the processor to control an additive manufacturing apparatus to manufacture a cartridge according to the first aspect.

According to a fifth aspect of the present disclosure, there is provided a method of manufacturing a product via additive manufacturing, the method comprising: obtaining an electronic file representing a geometry of a product wherein the product is a cartridge according to the first aspect; and controlling an additive manufacturing apparatus to manufacture, over one or more additive manufacturing steps, the product according to the geometry specified in the electronic file.

According to a sixth aspect of the present disclosure, there is provided a method for storing and dispensing liquid from a cartridge for use in an inkjet printer, the method comprising:

storing the liquid in a reservoir of the cartridge, the reservoir comprising a first region defined by a first wall portion and a second region defined by a second wall portion, the first and second regions being in fluid communication with each other;

supporting an electronic data storage device by the first wall portion;

dispensing the liquid from an outlet of the cartridge;

maintaining the electronic data storage device in a predetermined location relative to an electrical connection of the inkjet printer with the first wall portion; and

collapsing the second wall portion and reducing the volume of the second region of the reservoir.

The predetermined location may allow the electronic data storage device to establish an electrical contact with the electrical connection of the inkjet printer.

Maintaining the electronic data storage device and collapsing the second wall portion may occur during the dispensing of the liquid from the outlet of the cartridge.

Collapsing the second wall portion may comprise transforming the second wall portion from a filled state in which the second region is at least partially filled with the liquid to an empty state.

The second wall portion may comprise two opposing face walls and at least one peripheral wall connecting the two opposing face walls. Collapsing the second wall portion may comprise moving the two opposing face walls towards each other.

According to a seventh aspect of the present disclosure, there is provided a method for manufacturing a cartridge for use in an inkjet printer, the method comprising:

moulding a collapsible reservoir which encloses an internal space for storage of liquid, wherein the reservoir comprises a first wall portion and a second wall portion, and wherein: the first wall portion defines a first region of the internal space; the second wall portion defines a second region of the internal space, the first region and the second region being in fluid communication with one another; and the first wall portion and the second wall portion are configured such that at least a part of the second wall portion collapses more easily than the first wall portion when the liquid is withdrawn from the reservoir; and

forming, on the first wall portion, a structure configured to support an electronic data storage device.

The method may further comprise: forming a holder configured to receive the electronic data storage device; and attaching the holder to the first wall portion by engaging the holder with the structure.

It would be appreciated that the expressions “a structure configured to support an electronic data storage device” and “a holder configured to receive the electronic data storage device” may be used interchangeably with “a structure for supporting an electronic data storage device” and “a holder for receiving the electronic data storage device”, respectively, and do not imply any limitation to the presence of the electronic data storage device.

Alternatively, the structure may be configure to directly engage with the electronic data storage device.

The structure may be integrally formed with the first wall portion.

Moulding the collapsible reservoir may comprise using a rotational moulding process or a blow moulding process to mould the collapsible reservoir.

The method may further comprise moulding an outlet configured to dispense the liquid from the reservoir.

Features described above with reference to one aspect of the invention may be combined with other aspects of the invention.

Embodiments of the invention will now be described, by way of example only, with reference to the accompanying drawings in which:

FIG. 1 is an exploded, perspective view of a known cartridge;

FIG. 2 schematically illustrates a perspective view of a cartridge according to a first aspect of the present disclosure;

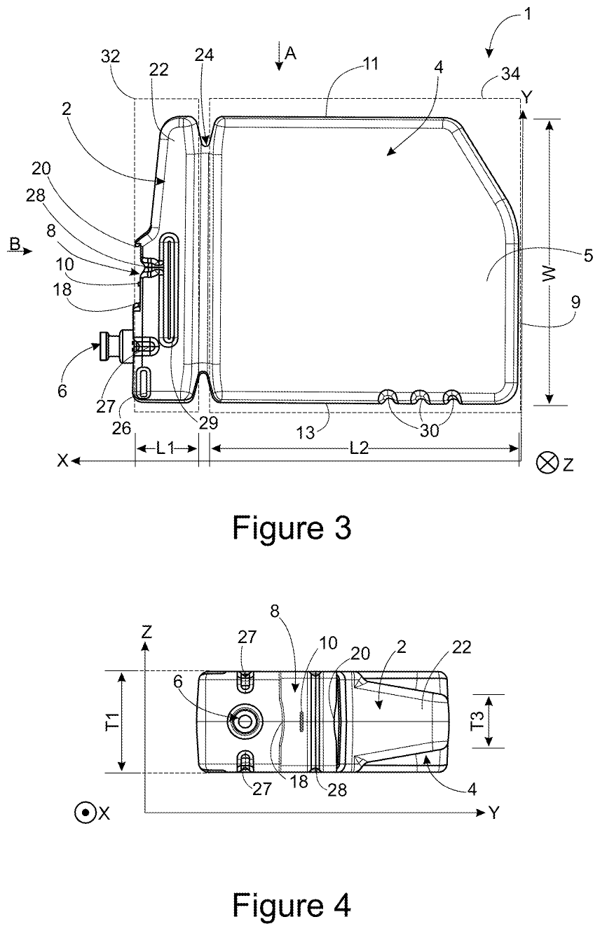

FIG. 3 schematically illustrates a front view of the cartridge shown in FIG. 2;

FIG. 4 schematically illustrates a side view of the cartridge shown in FIG. 3 when viewed along an arrow ‘B’ in FIG. 3;

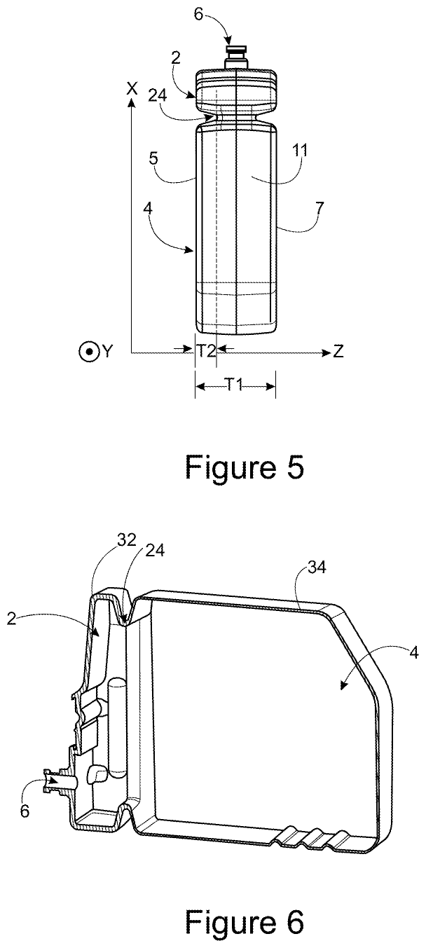

FIG. 5 schematically illustrates a top view of the cartridge shown in FIG. 3 when it is viewed along an arrow ‘A’ in FIG. 3;

FIG. 6 schematically illustrates a cross-sectional view of the cartridge shown in FIG. 3 when the cartridge is cut along a plane defined by the X and Y axes;

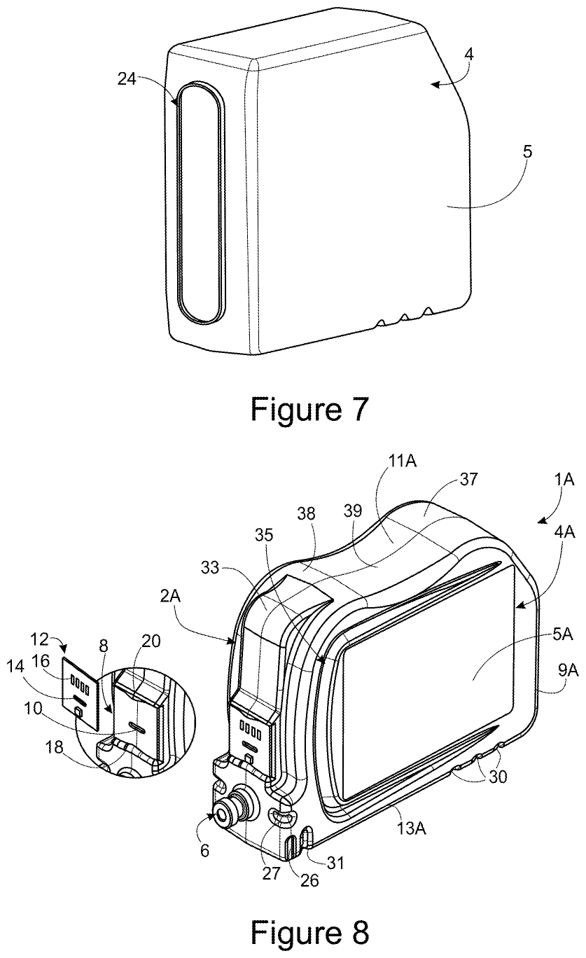

FIG. 7 schematically illustrates a cross-sectional view of the cartridge shown in FIG. 3 when the cartridge is cut at its linking structure along a plane defined by the Y and Z axes;

FIG. 8 schematically illustrates a perspective view of a cartridge according to a second aspect of the present disclosure;

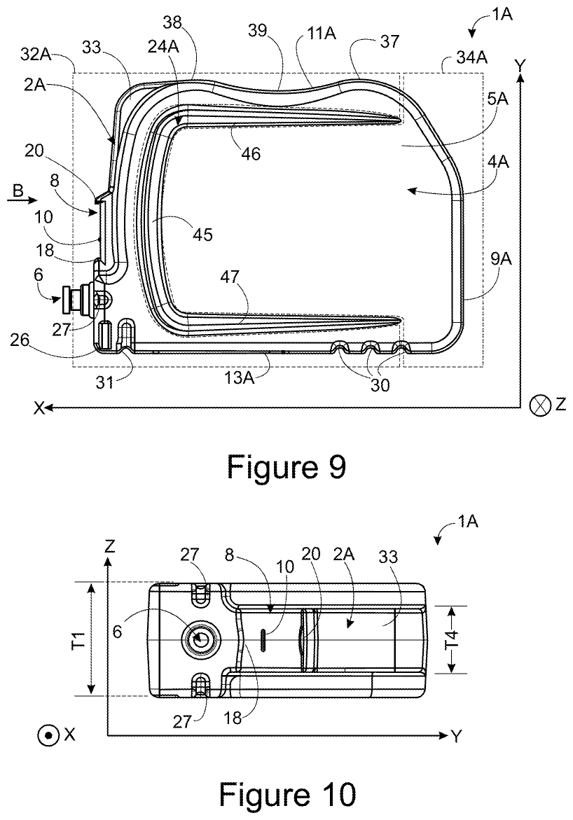

FIG. 9 schematically illustrates a front view of the cartridge shown in FIG. 8;

FIG. 10 schematically illustrates a side view of the cartridge shown in FIG. 9 when viewed along an arrow ‘B’ in FIG. 9;

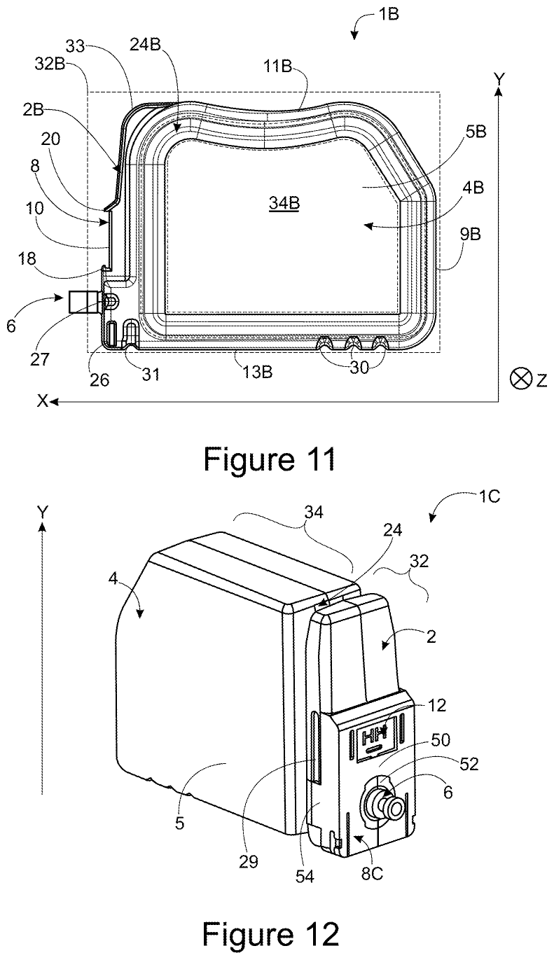

FIG. 11 schematically illustrates a front view of a cartridge according to a third aspect of the present disclosure;

FIG. 12 schematically illustrates a perspective view of a cartridge according to a fourth aspect of the present disclosure;

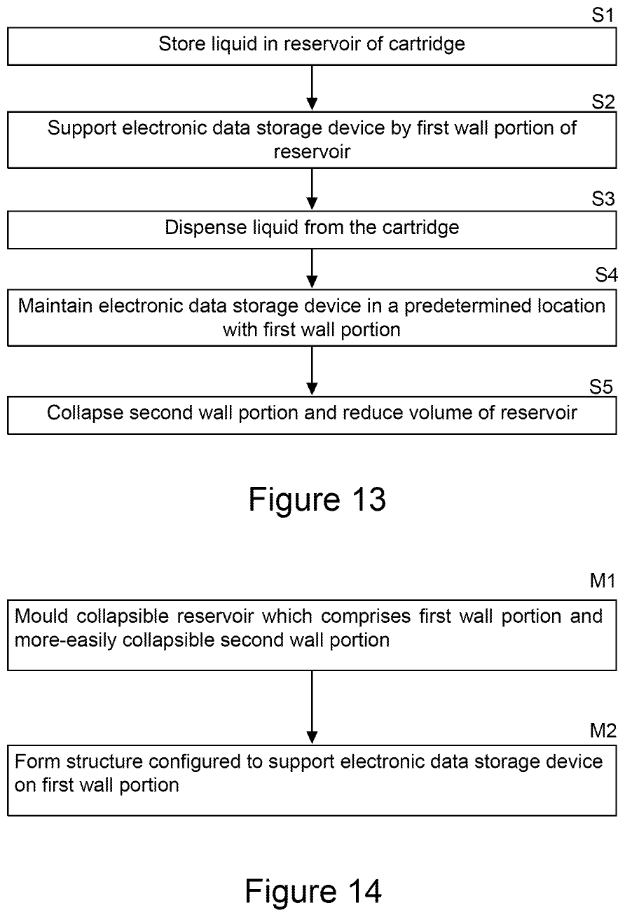

FIG. 13 shows process steps of a method for storing and dispensing liquid from a cartridge for use in an inkjet printer;

FIG. 14 shows process steps of a method for manufacturing a cartridge for use in an inkjet printer.

In the figures, like parts are denoted by like reference numerals. It will be appreciated that the drawings are for illustration purposes only and may not be drawn to scale.

A first embodiment of a cartridge 1 according to the present disclosure is schematically shown in FIGS. 2 to 5 and described in more detail below.

As illustrated in FIGS. 2 to 5, the cartridge 1 includes a reservoir which encloses an internal space for storage of liquid. The reservoir includes a first chamber 2 and a second chamber 4. The walls of the reservoir which define the first chamber 2 (i.e., the walls included within a virtual box 32 in FIG. 3) may be collectively referred to as a “first wall” 32 of the cartridge 1. The walls of the reservoir which define the second chamber 4 (i.e., the walls included within a virtual box 34 in FIG. 3) may be collectively referred to as a “second wall” 34 of the cartridge 1. The reservoir further includes a linking structure 24 which connects a boundary of the first wall 32 to a boundary of the second wall 34. In this embodiment, the linking structure takes the form of a collar 24. The collar 24 provides a fluid communication path between the first chamber 2 and the second chamber 4.

In the present disclosure, the terms “first wall” and “second wall” are used interchangeably with “first wall portion” and “second wall portion”, respectively. Moreover, the terms “first wall” or “first wall portion” are not intended to imply that the wall (or wall portion) is separated from a further (e.g. second) wall (or portion). Rather, the first and second walls or wall portions can be formed as different parts or portions of a contiguous wall.

Further, the terms “first chamber” and “second chamber” are used interchangeably with “first region” (or “first part”) and “second region” (or “second part”) of the internal space of the reservoir, respectively. Again, the “first chamber” and “second chamber” or “first region” (or “first part”) and “second region” (or “second part”) are not intended to imply any discontinuity or separation between the respective chambers, regions or parts. Rather the respective chambers, regions or parts may be connected to one another, but in some way spatially distinct.

The cartridge 1 also has an outlet 6 for dispensing the liquid from the reservoir to, for example, an ink supply system of an inkjet printer. The outlet 6 may be provided with a fluid-tight seal or valve (not shown) which forms a fluid-tight engagement with a fluid connector of the ink supply system. The liquid stored in the reservoir may, for example, include ink or solvent, or any other suitable liquid for use with the inkjet printer. In an example, the ink and/or solvent may include an organic solvent selected from C1-C4 alcohols, C4-C8 ethers, C3-C6 ketones, C3-C6 esters, and mixtures thereof. The reservoir defines a flow path originating from the second chamber 4, then leading through the collar 24, the first chamber 2, and then leading to the outlet 6. The fluid communication path provided by the collar 24 between the chambers 2, 4 does not go through the outlet 6.

The cartridge 1 is made of a non-elastic and flexible material. “Non-elastic” means that the material does not stretch easily under tension by becoming longer/wider and thinner. “Flexible” means that the material is able to bend or to deform easily.

With reference to FIGS. 2 to 5, the second chamber 4 of the reservoir has a box shape. In particular, the second chamber 4 is defined by opposing face walls 5, 7 (as shown in FIG. 5), and perimeter walls 9, 11, 13 (see FIG. 3) connecting the boundaries of the face walls 5, 7. The face walls 5, 7 are substantially parallel to each other as illustrated in FIG. 4. However, it will be appreciated that the face walls 5, 7 may also be arranged to form an angle therebetween. The face walls 5, 7 and the perimeter walls 9, 11, 13 are part of the second wall 34 described above. In use, a product label of the cartridge 1 may be adhered to the face walls 5, 7 across the perimeter wall 9. Therefore, the face walls 5, 7 are preferably flat and of a size large enough to accommodate the product label.

As shown in FIGS. 2, the first wall 32 of the first chamber 2 is provided with a holder 8 for releasably receiving an electronic data storage device 12. The electronic data storage device 12 includes electrical contacts 16 and a slot 14 for releasably engaging with a locking means 10 of the holder 8. The holder 8 further includes two clips 18 and 20 for releasably holding the electronic data storage device 12 therebetween. In an example, the electronic data storage device 12 may take the form of a data card, and the holder 8 may therefore be referred to as a card holder.

As shown in FIG. 3, the second chamber 4, the collar 24, the first chamber 2 and the outlet 6 are arranged along an X direction. The first chamber 2 has a length L1 along the X direction. The second chamber 4 has a length L2 along the X direction. L1 is shorter than L2. In an example, L1 is approximate to or less than a third of L2. Both the chambers 2, 4 have substantially the same maximum width W along a Y direction perpendicular to the X direction. The width W is shorter than a length of the cartridge 1 along the X direction. The volume of the first chamber 2 is much smaller than that of the second chamber 4. In an example, the volume of the first chamber 2 is approximate to or less than a third of a volume of the second chamber 4.

With further reference to FIG. 4, the second chamber 4 has a constant depth T1 along a Z direction which is perpendicular to both the X and Y directions. The first chamber 2 has the same depth T1 around the outlet 6 and at the holder 8. However, the first chamber 2 tapers to a rounded end 22 at the right side of the holder 8 (opposite to the outlet 6). More specifically, the depth of the first chamber 2 gradually decreases from T1 to a depth T3 at the right side of the holder 8 along the Y direction. In an example, the depth T3 is around a half of T1.

FIG. 5 illustrates a top view of the cartridge 1 when the cartridge 1 is viewed along the arrow CA′ in FIG. 3. As shown in FIG. 5, the collar 24 forms a narrow neck between the first chamber 2 and the second chamber 4, and has a depth which is less than the depth T1 of the second chamber 4. The collar 24 is recessed from the face wall 5 of the second chamber 4 by a depth T2. Similarly, the collar 24 is recessed from the face wall 7 by the same depth T2. In an example, T2 is less than a third of T1.

In a particular example, the entire length of the reservoir (excluding the outlet 6) along the X direction is around 180 mm, with L1 around 33 mm, and L2 around 140 mm; the width W of the reservoir is around 134 mm; the depth T1 of the reservoir is around 54 mm, with the minimum depth T3 of the tapered end 22 being around 27 mm, and the depth T2 of the collar 24 being around 15 mm; the overall volume of the reservoir is around 1000 ml, with the volume of the first chamber 2 being around 200 ml, and the volume of the second chamber 4 being around 800 ml. In an example, the weight of the cartridge 1 (without any liquid) is around 100 g.

The cartridge 1 is air-sealed and does not include any venting hole. “Air-sealed” means that the cartridge 1 prevents air from entering the internal space of the reservoir from outside of the cartridge 1 as the liquid is dispensed from the outlet 6. Therefore, the pressure within the reservoir of the cartridge 1 is generally maintained at a pressure lower than atmospheric pressure. With liquid being dispensed from the reservoir, the pressure within the reservoir of the cartridge 1 decreases and the reservoir collapses (or deforms) in order to accommodate the decreasing internal volume of the reservoir.

In use, the cartridge 1 is directly attached to an inkjet printer, without requiring any outer casing. In particular, when the cartridge 1 is correctly received by a mounting arrangement (e.g., a cartridge holder) of the inkjet printer, the outlet 6 is connected via fluid-tight means to a pump of an ink supply system of the inkjet printer so as to form a fluid communication with the printer, and the electronic data storage device 12 held by the holder 8 engages with a contact pad of the ink supply system so as to form an electrical communication.

To ensure that the fluid communication and the electrical communication between the cartridge 1 and the inkjet printer are not affected by the collapsing shape of the reservoir, the cartridge 1 has been designed such that the second wall 34 of the second chamber 4 collapses more easily than the first wall 32 of the first chamber 2 as liquid is being dispensed from the reservoir. This effect is attributed to one or more of the following features of the cartridge 1:

The thickness of the first wall 32 which defines the first chamber 2 is made greater than a thickness of the second wall 34 which defines the second chamber 4. This is shown in FIG. 6 which illustrates a cross-sectional view of the cartridge 1 when the cartridge 1 is cut along a plane defined by the X and Y axes. With the first wall 32 and the second wall 34 made of the same material, greater thickness improves the rigidity of the wall. Therefore, the first wall 32 is more rigid than the second wall 34. When the liquid is dispensed from the reservoir, the second wall 34 quickly and easily deforms to accommodate the reduced volume of the internal space of the reservoir caused by the dispensing of the liquid. As such, the first wall 32 would not substantially deform as liquid is dispensed from the outlet 6. Since the outlet 6 and the holder 8 are provided on the first wall 32, the fluid communication and the electrical communication between the cartridge 1 and the inkjet printer are not affected by the collapse of the second chamber 4 caused by the dispensing of the fluid.

In an example, the thickness of the second wall 34 may be around or less than a half of the thickness of the first wall 32. In a particular example where the length L1 of the first chamber 2 is around 33 mm, and the length L2 of the second chamber 4 is around 140 mm, with the first and second chambers 2, 4 having the same maximum width W of around 134 mm, the thickness of the first wall 32 is within a range of around 2 mm to around 3 mm, whilst the thickness of the second wall 34 is within a range of around 1 mm to around 1.2 mm.

It will be appreciated by the skilled person that the first wall 32 and the second wall 34 may be made of different materials, and by appropriately selecting the particular materials being used, the second wall 34 can be made more flexible than the first wall 32 so that the second wall 34 of the second chamber 4 collapses more easily than the first wall 32 of the first chamber 2 as liquid is being dispensed from the reservoir.

Further, the collar 24 effectively isolates deformation of the second wall 34 from the first wall 32, such that deformation of the second wall 34 would not substantially affect the structure or the shape of the first wall 32. Because the collar 24 is recessed from the face walls 5, 7 (shown in FIG. 5) and the perimeter walls 11, 13 (shown in FIG. 3) of the second chamber 4, the collar 24 has a smaller cross sectional size than the second chamber 4 along a plane defined by the Y and Z axes (which is perpendicular to a length of the cartridge 1 along the X axis). Due to its small cross-sectional size, the collar 24 is more rigid and structurally robust than the second wall 24, and thus is able to isolate deformation of the second wall 34 from the first wall 32.

In addition, as shown in FIGS. 3 and 5, the wall defining the collar 24 has a smooth profile. The term “smooth profile” is intended to mean that there are no abrupt changes in direction in the profile of the wall, allowing tensile stress to be distributed more evenly throughout the wall, rather than leading to stress concentrations. In particular, the wall defining the collar 24 is smoothly joined with the walls 32, 34 without causing any abrupt changes. Further, the cross section of the collar 24 along a plane defined by the Y and Z axes has rounded (smooth) edges and may have a generally oval shape in an example as shown in FIG. 7. The smooth profile of the wall defining the collar 24 allows stress concentrations to be reduced and is helpful to improve the robustness of the collar 24, such that the collar 24 or the fluid communication path provided thereby does not easily collapse as liquid is dispensed from the reservoir. Accordingly, the collar 24 effectively isolates deformation of the second wall 34 from the first wall 32, such that deformation of the second wall 34 would not substantially affect the structure or the shape of the first wall 32.

The collar 24 provides additional effects. In particular, the cartridge 1 can be conveniently held at the collar 24 when it is moving on a conveyer, or during liquid filling and capping processes. The wall defining the collar 24 has a smooth profile and may have a thickness of around 1 mm.

The first wall 32 is also provided with reinforcing structures 26, 27, 28, 29 which strengthen the rigidity of the first wall 32. As shown in FIGS. 2 to 4, the reinforcing structures 27 take the form of indents, and are provided at opposite sides of the outlet 6 to reinforce the rigidity of the first wall 32 around the outlet 6. The reinforcing structure 28 takes the form of a groove extending across the holder 8. The reinforcing structure 28 is positioned behind the electronic data storage device 12 when the device 12 is attached to the holder 8, and reinforces the rigidity of the holder 8. The reinforcing structures 26 are provided at two corners of the first chamber 2 adjacent to the outlet 6. The reinforcing structure 29 is provided between the holder 8 and the collar 24, and takes the form of a groove extending along the Y axis. The reinforcing structures 26 and 29 are also useful for locking the position of the cartridge 1 relative to an inkjet printer, by engaging with corresponding structures (e.g., protrusions) provided in the mounting arrangement (e.g., a cartridge holder) of the inkjet printer.

As described above, the first chamber 2 tapers to a rounded end 22 at the opposite side of the outlet 6. The tapered end 22 is also useful for improving the rigidity of the first wall 32. In particular, as shown in FIG. 4 and described above, the tapered end 22 has a smaller depth along the Z axis than the remaining part of the first chamber 2. Further, as shown in FIG. 3, the tapered end 22 has a smaller length along the X axis than the remaining part of the first chamber 2. The smaller depth and the smaller length of the tapered end 22 strengthens the first wall 32.

Further, as shown in FIGS. 3 and 5, the tapered end 22 has a larger cross-sectional size than the collar 24 along a plane defined by the Y and Z axes. However, the tapered end 22 is made of smooth arcuate walls which gradually curve away from the collar 24. In other words, continuous and smooth connections are formed between the tapered end 22 and the collar 24. This is advantageous in enhancing the structural robustness of the first chamber 2, as it serves to relieve the stress around the corner of the tapered end 22.

The cartridge 1 may have more head space as compared to the prior cartridge 100. In an example, the overall volume of the reservoir of the cartridge 1 is around 1000 ml, and the filling volume of liquid within the reservoir is 750 ml, leaving a head space of 250 ml for filling gas (e.g., air) into the cartridge 1. A pump providing 400 m bar vacuum may be used to withdraw the liquid from the cartridge 1. When all of the liquid has been withdrawn from the cartridge 1, the cartridge 1 becomes partially collapsed, achieving an empty internal space of 250 ml. The empty internal space of 250 ml is mainly provided by the first chamber 2 (which does not experience substantial deformation as the liquid is dispensed) and the collar 24. In other words, the second chamber 4 collapses to accommodate substantially all of the reduced volume of the internal space of the reservoir caused by the dispensing of the liquid. Since the position of the cartridge 1 is locked to the printer via structural features (e.g., the reinforcing structures 26 and 29) of the first wall 32 of the first chamber 2, the cartridge 1 is maintained securely in the mounting arrangement of the inkjet printer as the liquid is dispensed. Further since the outlet 6 and the holder 8 are provided on the first wall 32, the fluid communication between the outlet 6 and the printer and the electrical communication between the electronic data storage device 12 held by the holder 8 and the printer remain intact as the liquid is dispensed from the cartridge 1.

During a filling process of the cartridge 1, the cartridge 1 may be held in an orientation as shown in FIG. 5 with the outlet 6 on top of the first chamber 2 which is further above the second chamber 4. In general, a desired filling volume of liquid for the cartridge 1 may be up to a sum of the volume of the second chamber 4 and 40% of the volume of the first chamber 2, and the remaining of the volume of the first chamber 2 may be filled within gas during a filling process of the cartridge 1. An example of the gas is air but other types of gas may be used. In other words, the desired filing volume of liquid for the cartridge 1 may occupy substantially the full internal volume of the second chamber 4 (and optionally less than 40% of the volume of the first chamber 2), and the first chamber 2 may be largely unfilled by liquid but filled by gas to provide the head space. The filling volume of gas may be at least 60% of the volume of the first chamber 2. After the cartridge 1 is filled and capped, the gas pressure (e.g., air pressure) within the reservoir may be equal to or slightly lower than the atmospheric pressure. Because the cartridge 1 is air-sealed, the gas filled into the reservoir during the filling process would not be able to escape the reservoir.

Therefore, in order to achieve the same filing volume of liquid, the total volume of the cartridge 1 may be larger than that of the prior cartridge show in FIG. 1 because of the larger head space provided by the cartridge 1. Having a larger head space advantageously ensures that the first wall 32 would not experience significant deformation when substantially all of the liquid is withdrawn from the cartridge 1. In particular, when the cartridge 1 is installed in an inkjet printer, the cartridge 1 may be kept in an upside-down orientation with the outlet 6 below the first chamber 2 which is further below the second chamber 4, and accordingly the gas filled into the reservoir would move up to the second chamber 4. In this way, the first chamber 2 may be full of liquid, and the second chamber 4 may contain both liquid and gas. A pump which generates a negative pressure which is lower than the internal pressure of the cartridge 1 may be used to withdraw the liquid from the cartridge 1. When the liquid is dispensed from the outlet 6 to the printer, the gas volume inside the second chamber 4 would expand so as to take up the reduced volume of the liquid, thereby lowering the internal pressure of the reservoir. Consequently, the pressure difference between the outside of the cartridge (i.e., the atmospheric pressure) and the internal pressure of the reservoir would increase, thereby causing the second wall 34 to deform or collapse. This is because the second wall 34 is more flexible and deforms more easily than the first wall 32. With the second wall 34 collapsing, the gas inside the second chamber 4 and the remaining liquid move downwards into the first chamber 2. The pump continues to withdraw liquid from the cartridge 1 by generating a negative pressure. Once the second chamber 4 has collapsed completely, the amount of gas originally filled into the reservoir would occupy the first chamber 2. Since the original filling volume of gas within the reservoir is at least 60% of the volume of the first chamber 2 and further because this volume of gas fills the first chamber 2 at the end of liquid dispensing, the pressure difference between the internal space of the first chamber 2 and the outside of the cartridge 1 is not sufficient to crush the first wall 32 when all of the liquid has substantially been withdrawn from the reservoir. That is, the rigidity of the first wall 32 is sufficient to prevent collapse when the pressure is such that an initial volume of gas (at or slightly lower than the atmospheric pressure) of around 60% of the volume of the first chamber 2 is caused to expand to fill substantially the entire volume of the first chamber 2. Therefore, the first wall 32 and the first chamber 2 would not experience substantial deformation when all of the liquid is withdrawn from the reservoir. Since the holder 8 and the outlet 6 are provided on the first wall 32, the electrical contact between the electrical data storage device and the printer as well as the fluid connection between the outlet and the printer are ensured.

Regarding the prior cartridge 100 as shown in FIG. 1, it will be appreciated that the peripheral regions of the inner bottle 101 immediately adjacent to the perimeter walls 109 are more rigid, and more difficult to collapse as compared to the central regions of the face walls 105. However, since the bottle 101 is fully collapsible, the peripheral regions of the bottle 101 may still experience substantial deformation. For example, the bottle 101 may be deformed such that the perimeter walls 109 tilt away from its original orientations. Further, as the cartridge size is increased, for example, to achieve a high volume of internal space, the reinforcing effect provided by the perimeter walls 109 is generally not sufficient to maintain the shape of the perimeter walls 109 as liquid is dispensed from the bottle 101. If the electronic data storage device 108 were directly attached to a perimeter wall 109 of the bottle 101, and the bottle 101 were installed onto an inkjet printer without the outer casing 102, the perimeter wall 109 may tilt or deform otherwise as liquid is dispensed from the bottle 101 such that electronic data storage device 108 no longer forms an effective electrical contact with the inkjet printer. Therefore, it would be necessary for the prior cartridge 100 to include an outer casing 102 and to use the outer casing 102 to hold the electronic data storage device 108.

Because the cartridge 1 does not require an outer casing, the outer surface of the second chamber 4 forms part of an exterior surface of the cartridge 1, and the shape of the second chamber 4 determines the overall volume of the cartridge 1. Therefore, a collapse of the second chamber 4 reduces an overall volume of the cartridge 1.

As shown in FIGS. 2 and 3, the second wall 34 also includes reinforcing structures 30. The reinforcing structures 30 are provided on the perimeter wall 13 of the second chamber 4, and include an array of grooves each extending across the entire depth of the second chamber 4. The reinforcing structures 30 improve the rigidity of the perimeter wall 13, which contacts a surface of the mounting arrangement of the inkjet printer when the cartridge 1 is installed onto the printer.

It will be appreciated that the reinforcing structures 26 to 30 may take a different form, and some or all of the reinforcing structures 26 to 30 may be omitted.

A second embodiment of a cartridge 1A according to the present disclosure is schematically shown in FIGS. 8 to 10 and described in more detail below. Components of the second embodiment that are identical to those of the first embodiment are identified using the same labels. Components of the second embodiment that correspond to, but are different from those of the first embodiment are labelled using the same numerals but with a letter CA′ for differentiation. The features and advantages described above with reference to the first embodiment are generally applicable to the second embodiment.

As illustrated in FIGS. 8 to 10, the cartridge 1A includes a reservoir which encloses an internal space for storage of liquid. The internal space of the reservoir includes a first part 2A and a second part 4A which are in fluid communication with each other. The first part 2A and the second part 4A may also be referred to as a first chamber and a second chamber. The walls of the reservoir which define the first chamber 2A (i.e., the walls included within a virtual box 32A in FIG. 9) may be collectively referred to as a “first wall” 32A of the cartridge 1A. The walls of the reservoir which define the second chamber 4A (i.e., the walls included within a virtual box 34A in FIG. 9) may be collectively referred to as a “second wall” 34A of the cartridge 1A. As shown in FIG. 9, the first chamber 2A is generally U-shaped, and the second chamber 4A is generally of a T shape. The first chamber 2A partially surrounds the second chamber 4A. The first wall 32A includes perimeter walls 11A, 13A. The second chamber 4A is defined by opposing face walls 5A (FIG. 9), 7A (not shown), and a perimeter wall 9A (FIG. 9) connecting a part of the boundaries of the face walls 5A, 7A. The face walls 5A, 7A are substantially parallel to each other. The face walls 5A, 7A and the perimeter wall 9A are part of the second wall 34A. In use, a product label of the cartridge 1A may be adhered to the face walls 5A, 7A across the perimeter wall 9A. Therefore, the face walls 5A, 7A are preferably flat and of a size large enough to accommodate the product label.

The reservoir further includes a linking structure 24A which connects a part of the boundary of the first wall 32A to a part of the boundary of the second wall 34A (in particular, a part of the boundary of the face wall 5A). In this embodiment, the linking structure takes the form of a U-shaped groove 24A. FIG. 9 shows that the groove 24A partially surrounds the face wall 5A. The groove 24A is relatively deep. The depth of the groove 24A varies at different locations, and may be up to 15% of the maximum depth of the first chamber 2A or the second chamber 4A along the Z axis. Therefore, the groove 24A does not cut off the fluid path between the first chamber 2A and the second chamber 4A. Similar to the cartridge 1, the cartridge 1A is air-sealed and does not include any venting hole.

As shown in FIGS. 8 and 9, the cartridge 1A has an outlet 6 for dispensing liquid from the reservoir, and a holder 8 for releasably receiving an electronic data storage device 12. The outlet 6 and the holder 8 have identical structures to those of the cartridge 1, and are both provided on the first wall 32A.

In use, the cartridge 1A is directly received by a mounting arrangement (e.g., a cartridge holder) of an inkjet printer, without requiring any outer casing. To ensure that the fluid communication and the electrical communication between the cartridge 1A and the inkjet printer are not affected by the collapsing shape of the reservoir, the cartridge 1A has been designed such that the second wall 34A of the second chamber 4A collapses more easily than the first wall 32A of the first chamber 2A as liquid is being dispensed from the reservoir. This effect is attributed to one or more of the following features of the cartridge 1A:

The linking structure 24A has been designed to allow a part of the second wall 34A to deform more easily as liquid is being dispensed from the reservoir. As described above, the linking structure 24A of the cartridge 1A takes the form of a U-shaped groove. The U-shaped groove 24A extends along three sides of the face wall 5A. As shown in FIG. 9, the U-shaped groove 24A includes a first groove 45 which is adjacent to the holder 8 and generally extends along the Y axis, a second groove 46 and a third groove 47 which are adjacent to perimeter walls 11A and 13A of the first chamber 2A and are joined with two ends of the first groove 45 respectively. The U-shaped groove 24A surrounds a majority part of the face wall 5A. When liquid is dispensed from the reservoir, the U-shaped groove 24A allows the surrounded majority part of the face wall 5A to more easily deform towards the opposing face wall 7A so as to accommodate the new reduced volume of the reservoir. An identical groove 24A may also be provided to partially surround the face wall 7A of the second chamber 4A.

Further, the groove 24A effectively isolates deformation of the second wall 34A from the first wall 32A, such that deformation of the second wall 34A would not substantially affect the structure or the shape of the first wall 32A. As shown in FIG. 9 and described above, an outer boundary of the groove 24A coincides with a boundary of the first wall 32A, and an inner boundary of the groove 24A coincides with a boundary of the second wall 32A. Since the groove 24A is relatively deep, the groove 24A allow regions at its two sides to have different mechanical properties. Therefore, the groove 24A is able to isolate deformation of the second wall 34A from the first wall 32A.

In addition, the first wall 32A is provided with reinforcing structures 26, 27, 31, 33 which strengthen the rigidity of the first wall 32A. The reinforcing structures 26 and 27 are identical to those of the cartridge 1. The reinforcing structure 31 takes the form of a groove extending across an entire depth of the first chamber 2A along the Z axis. The reinforcing structure 33 is provided around an edge of the first chamber 2A and protrudes over the rest of the walls defining the edge, thereby improving the rigidity of the first wall 32A. As shown in FIG. 10, the reinforcing structure 33 has a depth T4 along the Z axis, which is smaller than an overall depth T1 of the first chamber 2A.

The thickness of the first wall 32A may be greater than a thickness of the second wall 34A, thereby further improving the rigidity of the first wall 32A as compared to the second wall 34A.

Similar to cartridge 1, the reservoir of the cartridge 1A is partially collapsible. That is, when liquid is dispensed from the cartridge 1A, the second wall 34A defining the second chamber 4A collapses to accommodate substantially all of the reduced volume of the internal space of the reservoir caused by the dispensing of the liquid, while the first wall 32A defining the first chamber 2A does not experience substantial deformation. Since the outlet 6 and the holder 8 are provided on the first wall 32A, the fluid communication between the outlet 6 and the printer and the electrical communication between the electronic data storage device 12 held by the holder 8 and the printer are not affected by the collapse of the second chamber 4A caused by the dispensing of the fluid. Therefore, the cartridge 1A can be directly installed onto an inkjet printer without requiring any outer casing.

As shown in FIGS. 8 and 9, the top perimeter wall 11A of the first chamber 2A has an undulating profile along the X axis, and includes a valley 39 sandwiched between ridges 37 and 38. The valley 39 has a large radius as shown in FIG. 8, which allows for easier collapsing of the valley 39 than the rest of the perimeter wall 11A. The ridges 37 and 38 allow the cartridge 1A to be easily gripped by a hand in use. The collapsing of the valley 39 does not affect the structure of the first wall 32A around the holder 8 and the outlet 6.

The cartridge 1A is similar to the cartridge 1 in all other aspects.

A third embodiment of a cartridge 1B according to the present disclosure is schematically shown in FIG. 11 and described in more detail below. Components of the third embodiment that are identical to those of the first and second embodiments are identified using the same labels. Components of the third embodiment that correspond to, but are different from those of the previous embodiments are labelled using the same numerals but with a letter CB′ for differentiation. The features and advantages described above with reference to the first and second embodiments are generally applicable to the third embodiment.

As illustrated in FIG. 11, the cartridge 1B includes a reservoir which encloses an internal space for storage of liquid. The internal space of the reservoir includes a first part 2B and a second part 4B which are in fluid communication with each other. The first part 2B and the second part 4B may also be referred to as a first chamber and a second chamber. The walls of the reservoir which define the first chamber 2B (i.e., the walls included within a virtual box 32B in FIG. 11) may be collectively referred to as a “first wall” 32B of the cartridge 1B. The walls of the reservoir which define the second chamber 4B (i.e., the walls included within a virtual box 34B in FIG. 11) may be collectively referred to as a “second wall” 34B of the cartridge 1B.

As shown in FIG. 11, the first chamber 2B is generally loop-shaped, and surrounds the second chamber 4B. The reservoir further includes a linking structure 24B which connects the inner boundary of the first wall 32B to the outer boundary of the second wall 34B. In this embodiment, the linking structure takes the form of a loop-shaped groove 24B. The first wall 32B includes the perimeter walls 9B, 11B and 13B, and a perimeter wall on which the holder 8 and the outlet 6 are provided. The second chamber 4B of the reservoir is defined by opposing face walls 5B (FIG. 11), 7B (not shown). The face walls 5B, 7B are substantially parallel to each other, and collectively provide the second wall 34B. FIG. 11 shows that the groove 24B completely surrounds the face wall 5B. The depth of the groove 24B varies at different locations, and may be between 5% and 15% of the maximum depth of the first chamber 2B or the second chamber 4B along the Z axis. Therefore, the groove 24B does not cut off the fluid path between the first chamber 2B and the second chamber 4B. Similar to the cartridges 1 and 1A, the cartridge 1B is air-sealed and does not include any venting hole.

Similar to the cartridge 1A, the linking structure 24B allows the second wall 34B to deform more easily as liquid is being dispensed from the reservoir. As shown in FIG. 11 and described above, the linking structure 24B takes the form of a loop-shaped groove which extends along (or surrounds) the entire periphery of the face wall 5B. When liquid is dispensed from the reservoir, the loop-shaped groove 24B allows the surrounded face wall 5B to more easily deform towards the opposing face wall 7B so as to accommodate the new reduced volume of the reservoir. An identical groove 24B may also be provided to surround the face wall 7B.

Further, the groove 24B effectively isolates deformation of the second wall 34B from the first wall 32B, such that deformation of the second wall 34B would not substantially affect the structure or the shape of the first wall 32B.

As shown in FIG. 11 and described above, an outer boundary of the groove 24B coincides with a boundary of the first wall 32B, and an inner boundary of the groove 24B coincides with a boundary of the second wall 32B. Since the groove 24B is relatively deep, the groove 24B allow regions at its two sides to have different mechanical properties. Therefore, the groove 24B is able to isolate deformation of the second wall 34B from the first wall 32B.

The cartridge 1B is similar to the cartridge 1A in all other aspects.

A fourth embodiment of a cartridge 1C according to the present disclosure is schematically shown in FIG. 12 and described in more detail below. Components of the fourth embodiment that are identical (or at least similar) to those of the first embodiment are identified using the same labels. Components of the fourth embodiment that correspond to, but are different from those of the previous embodiments are labelled using the same numerals but with a letter ‘C’ for differentiation. The features and advantages described above with reference to the first embodiment are generally applicable to the fourth embodiment.

The reservoir of the cartridge 1C is similar to that of the cartridge 1. More specifically, the reservoir of the cartridge 1C includes a first chamber 2 and a second chamber 4. The walls of the reservoir which define the first chamber 2 are collectively referred to as a “first wall portion” 32. The walls of the reservoir which define the second chamber 4 are collectively referred to as a “second wall portion” 34. The reservoir further includes a collar 24 which connects a boundary of the first wall portion 32 to a boundary of the second wall portion 34. The collar 24 provides a fluid communication path between the first chamber 2 and the second chamber 4. The reservoir further includes an outlet 6 provided on the first wall portion 32. The first wall portion 32 includes a reinforcing structure 29 which takes the form of a groove extending along the Y axis. The second wall portion 34 comprises two opposing face walls (with one labelled as 5 in FIG. 12) and perimeter walls connecting the face walls.

The cartridge 1C differs from the cartridge 1 in the holder 8C. The holder 8 of the cartridge 1 is integrally formed with the first wall portion 32. However, the holder 8C of the cartridge 1C is separately formed and then attached to the first wall portion 32. An electronic data storage device 12 is then attached to the holder 8C.

As shown in FIG. 12, the holder 8C comprises a base plate 50 and two side arms (with one labelled as 54 in FIG. 12) extending from opposite sides of the base plate 50. An aperture 52 extends through the base plate 50 and has a greater dimension than the outlet 6. To attach the holder 8C to the first wall portion 32, the outlet 6 passes through the aperture 52, and the side arms 54 snaps into the groove of the reinforcing structure 29. Therefore, the holder 8C is releasably attached to the first wall portion 32 by a snap-fit connection.

The holder 8C is made more rigid than the first wall portion 32. Therefore, as liquid is withdrawn from the reservoir, the holder 8C adds stiffness to the first chamber 2, thus maintaining the electrical contact between the electronic data storage device 12 and an electrical connection of an inkjet printer. The second chamber 4 collapses as in the cartridge 1 during the dispensing of the liquid.

It would be understood that the holder 8C may be attached to the first wall portion 32 in a different manner. For example, the holder 8C may snap into a different structure of the first wall portion 32, or may be releasably attached to the first wall portion 32 by using a connection different from snap-fit. Alternatively, the holder 8C may be securely attached to the first wall portion by, e.g., using an adhesive.

It would further be understood that the cartridges 1A and 1B may be modified by replacing their holder 8 with the holder 8C.

The cartridges 1, 1A, 1B and 1C may be formed from a thermoplastic material, suitably by rotational moulding or blow moulding. The thermoplastic material may, for example, be high density polyethylene (HDPE). HDPE provides a high strength-to-density ratio and is resistant to many different solvents. It will be appreciated that by rotational moulding or blow moulding, the body of the cartridge 1, 1A, 1B and 1C, including the reservoir and the outlet 6 can be formed at the same time as a single-piece item. The holder 8C of the cartridge 1C may also be moulded using a thermoplastic material. To make the holder 8C more rigid than the first wall portion 32, the material of the holder 8C may be different, more rigid, than the material of the first wall portion 32. Alternatively, where the holder 8C and the first wall portion 32 are made of the same material, the holder 8C may have a greater thickness than the first wall portion 32.

As described above, different parts of the cartridge may be made of walls having different thicknesses. The various wall thickness may be achieved by controlling the thickness of parison walls in extrusion blow moulding process. The parison is a plastic melt which is heated and plasticized and is extruded from a core gap to form a cylindrical shape that is shaped against the inner wall of a mould by air pressure. The wall thickness of the cylindrical-shaped parison may be controlled by a controller of the moulding machine.

Alternatively, the cartridges 1, 1A, 1B and 1C may be formed using an additive manufacturing process. The present disclosure therefore also includes methods of manufacturing the cartridges via additive manufacturing and computer software, firmware or hardware for controlling the manufacture of such products via additive manufacturing. As used herein, “additive manufacturing” refers generally to manufacturing processes wherein successive layers of material(s) are provided on each other to “build-up” layer-by-layer or “additively fabricate”, a three-dimensional component. A common example of additive manufacturing is 3D printing; however, other methods of additive manufacturing are available. Rapid prototyping or rapid manufacturing are also terms which may be used to describe additive manufacturing processes. Additive manufacturing processes typically fabricate components based on three-dimensional (3D) information, for example a three-dimensional computer model (or design file), of the component. A design file, or computer aided design (CAD) file, is a configuration file that encodes one or more of the surface or volumetric configuration of the shape of the product, and can take any now known or later developed file format.

The structure of one or more parts of the cartridge described herein may be represented digitally in the form of a design file, and the design file may be produced using modelling (e.g. CAD modelling) software and/or through scanning the surface of a physical cartridge (e.g., a cartridge prototype) to measure the surface configuration of the cartridge. Once obtained, the design file may be converted into a set of computer executable instructions that, once executed by a processer, cause the processor to control an additive manufacturing apparatus to produce a cartridge according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. Design files or computer executable instructions may be stored in a transitory or non-transitory computer readable storage medium. The code or instructions may be translated between different formats, converted into a set of data signals and transmitted, received as a set of data signals and converted to code, stored, etc., as necessary. The instructions may be an input to the additive manufacturing system, which may execute the instructions to fabricate the cartridges described herein.

The cartridges as described herein may be used in an inkjet printer, such as a continuous inkjet printer.

FIG. 13 schematically illustrates processing steps of a method for storing and dispensing liquid from a cartridge (e.g., the cartridge 1, 1A to 1C) for use in an inkjet printer.

At step S1, the liquid is stored in a reservoir of the cartridge. The reservoir comprises a first region (e.g., the first chamber 2, 2A or 2B) defined by a first wall portion (e.g., the first wall 32, 32A or 32B) and a second region (e.g., the second chamber 4, 4A or 4B) defined by a second wall portion (e.g., the second wall 34, 34A or 34B). The first and second regions are in fluid communication with each other.

At step S2, an electronic data storage device (e.g., the device 12) is supported by the first wall portion.

At step S3, the liquid is dispensed from an outlet (e.g., the outlet 6) of the cartridge.

At step S4, the electronic data storage device is maintained in a predetermine location relative to an electrical connection of the inkjet printer.

At step S5, the second wall portion is collapsed and the volume of the second region of the reservoir is reduced.

The predetermined location generally allows the electronic data storage device to establish an electrical contact with the electrical connection of the inkjet printer.

Steps S4 and S5 may take place concurrently with step S3.

At step S5, the collapsing of the second wall portion may comprise transforming the second wall portion from a filled state in which the second region is at least partially filled with the liquid to an empty state. In a particular example, the second wall portion may comprise two opposing face walls (e.g., face walls 5, 7) and at least one peripheral wall (e.g., perimeter walls 9, 11, 13) connecting the two opposing face walls, and collapsing the second wall portion may comprise moving the two opposing face walls towards each other.

FIG. 14 schematically illustrates processing steps of a method for manufacturing a cartridge (e.g., the cartridge 1, 1A to 1C) for use in an inkjet printer.

At step M1, a collapsible reservoir for enclosing an internal space for storage of liquid is moulded. The reservoir comprises a first wall portion (e.g., the first wall 32, 32A or 32B) and a second wall portion (e.g., the second wall 34, 34A or 34B). The first wall portion defines a first region (e.g., the first chamber 2, 2A or 2B) of the internal space; the second wall portion defines a second region (e.g., the second chamber 4, 4A or 4B) of the internal space. The first region and the second region are in fluid communication with one another. The first wall portion and the second wall portion are configured such that at least a part of the second wall portion collapses more easily than the first wall portion when the liquid is withdrawn from the reservoir.

At step M2, a structure (e.g., the holder 8 or the reinforcing structure 29) for supporting an electronic data storage device (e.g., the device 12) are formed on the first wall portion.

The structure (e.g., the holder 8) may directly support the electronic data storage device.

Alternatively, the structure (e.g., the reinforcing structure 29) may support an intermediate element (e.g., the holder 8C) on which the electronic data storage device is mounted. In this embodiment, the method may further comprise a step of forming a holder (e.g., the holder 8C) for receiving the electronic data storage device, and a step of attaching the holder to the first wall portion by engaging the holder with the structure.

The method may comprise a further step M3 in which an outlet for dispensing the liquid from the reservoir is moulded. Step M3 may take place concurrently with step M1.

It would be appreciated that in practice, the steps described above may be performed in a temporal order that is different from the order of description. For example, step M2 may be performed simultaneously with step M1.

It will, of course, be appreciated that where terms such as “right”, “top”, “side” and “front” have been used to describe the cartridge, this is not intended to have any particular significance or imply any limitation. These terms are simply used for ease of reference to refer to the particular orientation which is illustrated in the figures.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1-31. (canceled)

32. A cartridge for storing and dispensing liquid for use with an inkjet printer, the cartridge comprising:
a collapsible reservoir enclosing an internal space for storage of the liquid, wherein: the reservoir comprises a first wall portion and a second wall portion, the first wall portion defining a first region of the internal space, the second wall portion defining a second region of the internal space, the first region and the second region being in fluid communication with each another; and
the first wall portion and the second wall portion are configured such that at least a part of the second wall portion collapses more easily than the first wall portion when the liquid is withdrawn from the reservoir;
an outlet configured to dispense the liquid; and
a holder configured to receive an electronic data storage device, wherein the holder is provided on the first wall portion.

33. The cartridge as recited in claim 32, wherein the holder is integrally formed with the first wall portion.

34. The cartridge as recited in claim 33, wherein the cartridge is a unitary cartridge.

35. The cartridge as recited in claim 32, wherein the reservoir is configured such that a collapse of the second wall portion reduces an overall volume of the cartridge.

36. The cartridge as recited in claim 32, wherein the outlet is provided on the first wall portion.

37. The cartridge as recited in claim 32, wherein the reservoir is partially collapsible.

38. The cartridge as recited in claim 32, wherein the second wall portion is made of a non-elastic and flexible material.

39. The cartridge as recited in claim 32, wherein the first wall portion comprises a first reinforcing structure which is configured to reinforce the rigidity of at least a part of the first wall portion.

40. The cartridge as recited in claim 39, wherein the holder is releasably attached to the first wall portion, and wherein the holder is configured to releasably engage with the first reinforcing structure.

41. The cartridge as recited in claim 32, wherein the cartridge is adapted to prevent air from entering the internal space from outside of the cartridge as the liquid is dispensed from the outlet.

42. The cartridge as recited in claim 32, wherein the cartridge is for use with a continuous inkjet printer.

43. The cartridge as recited in claim 32, wherein the reservoir further comprises a linking structure which links at least a part of a boundary of the first wall portion to at least a part of a boundary of the second wall portion.

44. The cartridge as recited in claim 43, wherein the linking structure comprises a collar which defines a fluid communication path between the first region and the second region, and a cross section of the fluid communication path has a smaller size than a cross section of the first region and/or the second region.

45. The cartridge as recited in claim 32, wherein a material of the at least a part of the second wall portion is more flexible than a material of the first wall portion.

46. The cartridge as recited in claim 32, wherein a thickness of the at least a part of the second wall portion is thinner than a thickness of the first wall portion.

47. The cartridge as recited in claim 32, wherein the first region comprises a tapered end.

48. An inkjet printer comprising:
the cartridge as recited in claim 32,
an electronic data storage device received by the holder of the cartridge, and
a mounting arrangement which directly receives the cartridge.

49. A method for storing and dispensing liquid from a cartridge for use in an inkjet printer, the method comprising:
storing the liquid in a reservoir of the cartridge, the reservoir comprising a first region defined by a first wall portion and a second region defined by a second wall portion, the first and second regions being in fluid communication with each other;
supporting an electronic data storage device by the first wall portion;
dispensing the liquid from an outlet of the cartridge;
maintaining the electronic data storage device in a predetermined location relative to an electrical connection of the inkjet printer with the first wall portion; and
collapsing the second wall portion and reducing the volume of the second region of the reservoir.

50. The method as recited in claim 49, wherein the predetermined location allows the electronic data storage device to establish an electrical contact with the electrical connection of the inkjet printer.

51. The method as recited in claim 49, wherein maintaining the electronic data storage device and collapsing the second wall portion occurs during the dispensing of the liquid from the outlet of the cartridge.

52. A method for manufacturing a cartridge for use in an inkjet printer, the method comprising:
moulding a collapsible reservoir which encloses an internal space for storage of liquid, wherein the reservoir comprises a first wall portion and a second wall portion, and wherein: the first wall portion defines a first region of the internal space; the second wall portion defines a second region of the internal space, the first region and the second region being in fluid communication with one another; and the first wall portion and the second wall portion are configured such that at least a part of the second wall portion collapses more easily than the first wall portion when the liquid is withdrawn from the reservoir; and
forming, on the first wall portion, a structure configured to support an electronic data storage device.

53. The method as recited in claim 52, further comprising: forming a holder configured to receive the electronic data storage device; and attaching the holder to the first wall portion by engaging the holder with the structure.
